(19) United States
(12) Patent Application Publication
(10) Pub. No.: US 2021/0010908 A1
(43) Pub. Date: Jan. 14, 2021

(54) TIRE TESTING MACHINE AND TIRE MARKING METHOD

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/040,704

(22) PCT Filed: Mar. 8, 2019
(86) PCT No.: PCT/JP2019/009253

§ 371 Date: Sep. 23, 2020

(30) Foreign Application Priority Data
Mar. 29, 2018 (JP) 2018-064489
Mar. 1, 2019 (JP) 2019-037735

(51) Int. Cl. G01M 17/02

(52) U.S. Cl. CPC G01M 17/024

(57) ABSTRACT

The present invention includes a belt conveyor (14) including a conveyance belt configured to convey downstream a tire (T) having been subjected to a tire test and detached from a spindle unit (9), the conveyance belt which is a loop-shaped strip forming an endless track, a drive mechanism (60) including a drive section configured to drive the conveyance belt and a control section configured to operate the drive section for control of a conveyance position of the conveyance belt, a first marking mechanism (61) configured to stamp, in accordance with a first stamping system, a first mark indicating a result of the tire test on the tire (T) mounted on the conveyance belt, and a second marking mechanism (62) configured to stamp, in accordance with a second stamping system different from the first stamping system, a second mark indicating a result of the tire test on the tire (T) mounted on the conveyance belt.

### TECHNICAL FIELD

The present invention relates to a technique relevant to a tire testing machine, and particularly to a method of marking a result of a tire test on a tire.

### BACKGROUND ART

There has conventionally been known a tire testing machine configured to test a plurality of tires having varied inner circumferential diameters or varied tread surface widths (e.g. Patent Literature 1). The tires having been tested have marks indicating results of the tire test and provided by a marking device on side wall surfaces of the tires. Examples of the marks include a high point mark and a grade mark.

The high point mark indicates a portion of each of the tires having a maximum value of a linear waveform for force variation, that is, a hardest portion in a tread surface. The high point mark is stamped at the portion having the maximum value (a phase having the maximum value detected) on the side wall surface of the tire.

The grade mark indicates a grade of a tire. The grade of the tire (tire grade) is determined in accordance with preliminarily set various measured items and results of the measurement. There is preliminarily set a plurality of grades respectively having a plurality of preliminarily set grade marks. The grade marks each have combination of a mark shape, a color, the number of lines, and the like preliminarily set. The grade marks are also stamped on the side wall surfaces of the tires.

A grade mark is typically stamped at a position close to a high point mark, but may be stamped at any position on the side wall surface. There may alternatively be provided a mark indicating a high point and a grade combined together.

Each of the marks is provided in accordance with, for example, a method which includes printing with use of a thermal transfer tape or a method which includes printing with use of ink. Each of the marks is provided at a site less likely to have lack in the mark in the side wall surface of the tire.

The marking device may be of a type of providing a mark on a tire mounted to a spindle, or of a type of providing a mark on the tire detached from the spindle and disposed on a conveyor. The marking device typically includes a mechanism configured to finely adjust a marking position in a radial direction on a side wall surface of a tire, and the mechanism is configured to adjust the marking position to an appropriate radial position.

In the case of providing a mark on the tire kept mounted to the spindle, the spindle is unavailable to a subsequent tire test because the tire is kept mounted to the spindle until marking of the tire completes. This accordingly inhibits quick transition to the subsequent tire test. Tire tests thus have cycle time loss with long cycle time.

A conveyance roller adopting a roller conveyor system conventionally applied to tire conveyance has problems such as phase change caused by rotation of the tire being shifted due to vibration of the conveyance roller. It is thus difficult to precisely mark on the tire mounted on such a roller conveyor.

### CITATION LIST

### Patent Literature

Patent Literature 1: JP 6034759 B2

### SUMMARY OF INVENTION

It is an object of the present invention to provide a tire testing machine and a method of marking a tire with use of the tire testing machine, which enable provision of a mark indicating a result of a tire test at a precise position on the tire as well as shorten cycle time of the tire test.

A tire testing machine according to the present invention includes: a belt conveyor including a conveyance belt configured to convey, downstream in a conveyance direction, a tire having been subjected to a tire test and detached from a spindle unit, the conveyance belt which is a loop-shaped strip forming an endless track; a drive mechanism including a drive section configured to drive the conveyance belt, and a control section configured to operate the drive section for control of a conveyance position of the conveyance belt; and a marking device including a first marking mechanism configured to stamp, in accordance with a first stamping system, a first mark indicating a result of the tire test on the tire mounted on the conveyance belt, and a second marking mechanism configured to stamp, in accordance with a second stamping system different from the first stamping system, a second mark indicating a result of the tire test on the tire mounted on the conveyance belt.

### BRIEF DESCRIPTION OF DRAWINGS

FIG. 1 is a plan view of a tire testing machine according to an embodiment of the present invention.

FIG. 2 is a front view of the tire testing machine according to the embodiment of the present invention.

FIG. 3 is a side view, from an inlet, of the tire testing machine according to the embodiment of the present invention.

FIG. 4 is a schematic plan view of a marking section included in the tire testing machine.

FIG. 5 is a schematic front view of the marking section included in the tire testing machine.

FIG. 6 is a plan view schematically depicting an entire configuration of the tire testing machine.

### DESCRIPTION OF EMBODIMENTS

A tire testing machine 1 and a tire marking method with use of the tire testing machine 1 according to an embodiment of the present invention will now be described hereinafter with reference to the figures.

The embodiment to be described below specifically exemplifies the present invention that should not be limited in terms of configurations thereof by such specific exemplification.

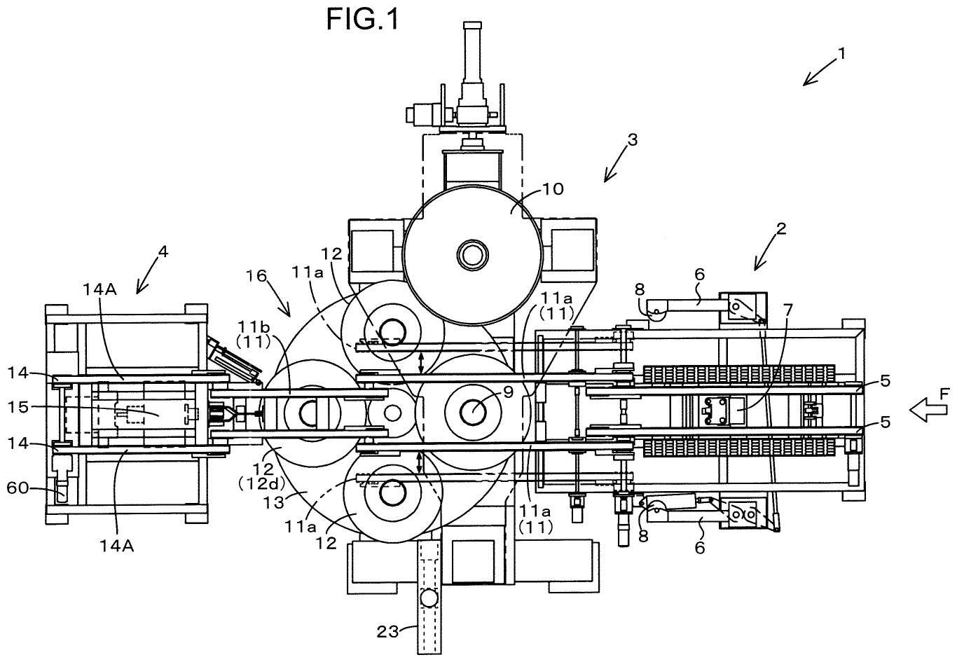

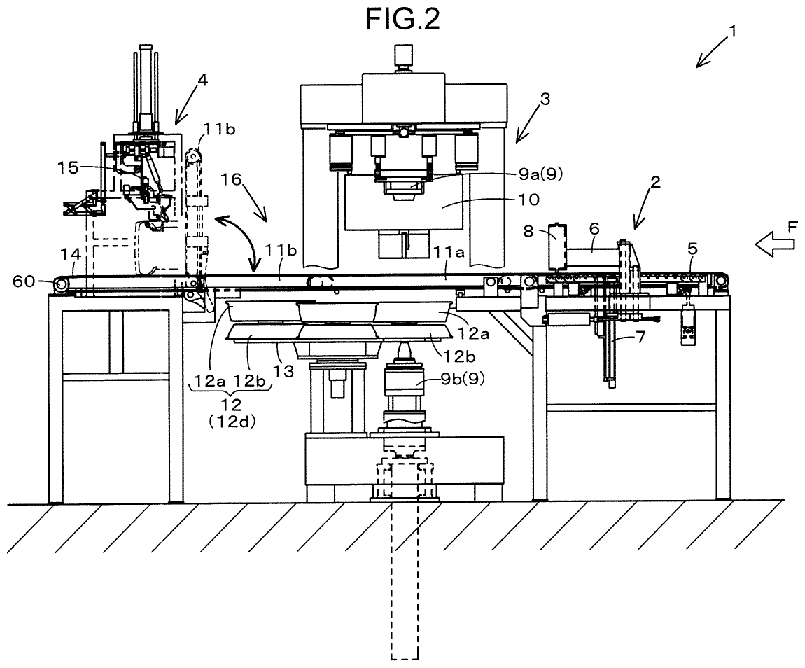

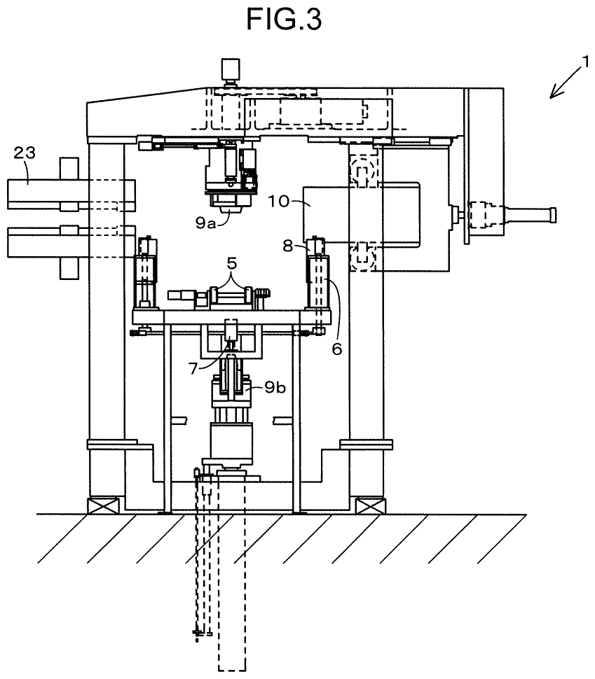

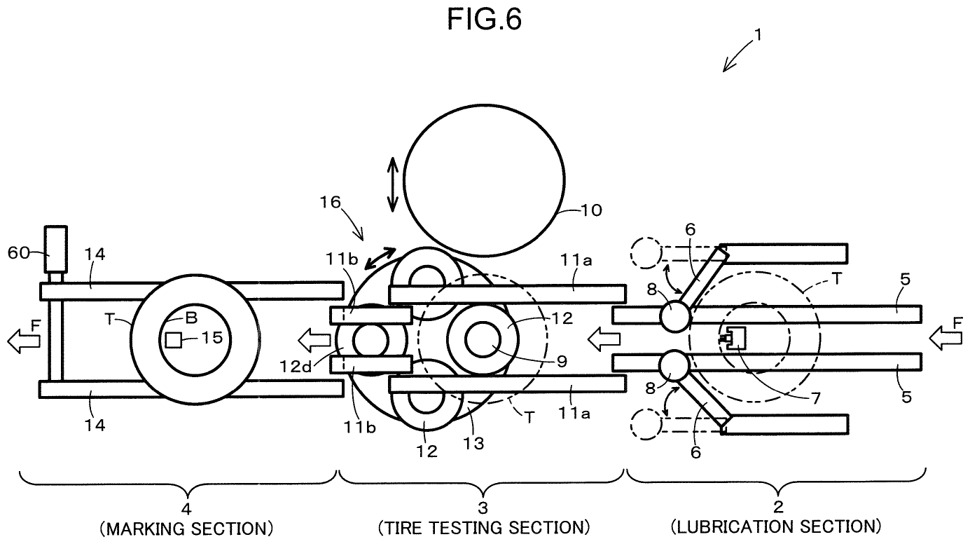

FIG. 1 to FIG. 6 each depict the tire testing machine 1 according to the embodiment.

The tire testing machine 1 to be described hereinafter has an entire length corresponding to a length of a conveyance route F of a tire T in a conveyance direction of the tire T. The tire testing machine 1 has a depth direction corresponding to a horizontal direction crossing the conveyance route F, more precisely, the horizontal direction substantially perpendicular to the conveyance route F. The depth direction will also be called a transverse direction or a width direction of the tire testing machine 1.

The tire testing machine 1 includes a lubrication section 2, a tire testing section 3, and a marking section 4. The lubrication section 2 rotates the tire T and simultaneously applies lubrication liquid to a bead portion B of the tire T. The tire testing section 3 causes the tire T provided with the lubrication liquid by the lubrication section 2 to rotate on a spindle unit, and simultaneously conducts a tire test to detect any singular point on the tire T. The marking section 4 marks a circumferential position of the singular point on the tire T.

The lubrication section 2, the tire testing section 3, and the marking section 4 are aligned in the mentioned order from an upstream side to a downstream side on the conveyance route F.

The lubrication section 2 includes a pair of left and right first conveyors 5 configured to convey the tire T laid horizontally, a pair of left and right arms 6 configured to hold the tire T delivered by the pair of first conveyors 5, and an applicator 7 configured to apply lubrication liquid to the bead portion B (inner circumferential edge) of the tire T held between the pair of arms 6.

Each of the first conveyors 5 according to the present embodiment is constituted as a belt conveyor including a conveyance belt which is a loop-shaped strip forming an endless track, but the first conveyors 5 should not be limited to such a belt conveyor system.

The paired arms 6 each have a tip provided with a rotatable roller 8. The pair of arms 6 in the lubrication section 2 sandwiches the delivered tire T from both left and right outer sides, and causes the rollers 8 to come into contact with a tread surface constituting an outer circumferential surface of the tire T. The rollers 8 rotate to allow the tire T to rotate about a vertical axis. The applicator 7 is configured to be vertically shiftable. The applicator 7 has a brush shape and is configured to ascend to come into contact with the bead portion B of the tire T held between the pair of arms 6 and apply the lubrication liquid to the bead portion B. After the application, the applicator 7 is returned to a position below the first conveyors 5 to be restored.

The pair of first conveyors 5 conveys the tire T thus provided with the lubrication liquid from the lubrication section 2 to the tire testing section 3.

The tire testing section 3 includes a spindle unit 9, a drum 10, a pair of left and right second conveyors 11, a rim table 13, and a rim replacing mechanism 16.

The spindle unit 9 holds the tire T rotatably about the vertical axis. The drum 10 has a cylindrical outer circumferential surface having a vertically directed center axis, and is disposed laterally to the spindle unit 9 so as to be rotatable about the center axis.

The pair of second conveyors 11 conveys the tire T delivered from the lubrication section 2 and kept laid horizontally. The rim table 13 has a horizontal rim mounting surface allowing a plurality of rims 12 to be mounted thereon. The rim replacing mechanism 16 replaces the rim 12 attached to the spindle unit 9 (specifically, an upper spindle 9a and a lower spindle 9b to be described later) with another rim.

The paired second conveyors 11 according to this embodiment are each constituted by an upstream conveyor 11a and a downstream conveyor 11b disposed downstream of the upstream conveyor 11a in the conveyance direction. The upstream and downstream conveyors 11a and 11b are each constituted as a belt conveyor including a conveyance belt which is a loop-shaped strip forming an endless track. The tire testing section 3 further includes a rotary drive section (not depicted) configured to rotationally drive the spindle unit 9.

The tire testing machine 1 further includes a grinder 23. When the tire T has a value exceeding an allowable value for a tire test, the grinder 23 grinds a shoulder at a boundary between the tread surface and a side wall surface of the tire T. The grinder 23 is disposed adjacent to an outlet of the tire testing section 3. The tire T is thus adjusted to have a value within the allowable value for the tire test.

The spindle unit 9 holds the tire T rotatably about the vertical axis via the rim 12. The spindle unit 9 has a structure divided into two parts, namely, the upper spindle 9a and the lower spindle 9b. The upper spindle 9a and the lower spindle 9b are bar members rotatable about a common vertical axis.

The rims 12 are each constituted by an upper rim 12a attached to a lower end of the upper spindle 9a, and a lower rim 12b attached to an upper end of the lower spindle 9b. The upper rim 12a and the lower rim 12b are disposed to vertically sandwich the tire T disposed on the pair of second conveyors 11. The rims 12 are each halved into the upper rim 12a and the lower rim 12b.

The rim table 13 is disposed adjacent to the lower spindle 9b. The rim table 13 can be provided thereon with the rim 12 including the upper rim 12a and the lower rim 12b stacked together.

The rim table 13 is made of a disc plate member, is rotatable about a vertical axis, and is disposed to have a rotary center axis positioned closer to an export port (outlet) than the spindle unit 9 in the conveyance direction. The rim table 13 can be provided thereon with a plurality of rims 12 (each including the upper rim 12a and the lower rim 12b stacked together) which is varied in size and can be attached to the upper spindle 9a and the lower spindle 9b, at a plurality of positions aligned in a rotary circumferential direction on the rim mounting surface. The rim table 13 according to the present embodiment is constituted as a rotary table, and can be provided thereon with four rims 12 varied in size and aligned in the rotary circumferential direction.

The drum 10 is disposed adjacent to the spindle unit 9 such that the outer circumferential surface of the drum 10 can be radially close to and separate from the tread surface of the tire T held by the spindle unit 9. The tire T is tested while rotating at predetermined rotational speed in a state where the outer circumferential surface of the drum 10 is in contact with the tread surface of the tire T held by the spindle unit 9. The drum 10 has a rotary shaft provided with a load cell (not depicted) configured to measure force, a moment, or the like applied from the rotating tire T to the drum 10.

Tire uniformity or the like is calculated from a result of measurement by the load cell. Measured as a “singular point” is a circumferential position, an axial position, or the like where the tire T has the largest repulsive force. The tire testing section 3 conducts the tire test including measurement of the tire uniformity as well as measurement of an outer shape and the like.

The tire T having the “singular point” thus measured is rotated at the tire testing section 3 by a determined angle according to a marking position at the “singular point”, and is then sent from the tire testing section 3 to the marking section 4.

In a case where the tire testing section 3 conducts the tire test relevant to tire uniformity of the tire T, the marking section 4 provides the circumferential position on the tire T having a “singular point” in terms of the tire uniformity with a mark like a uniformity mark indicating the singular point specified in the tire test. In another case where the tire test being conducted is relevant to measurement of the outer shape or the like, the tire T may be provided with a mark other than the uniformity mark.

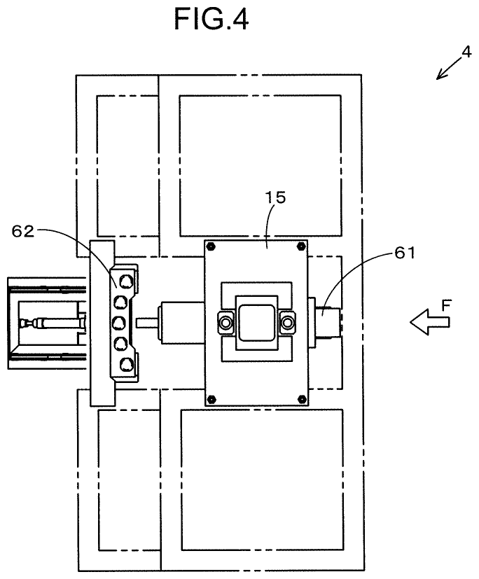

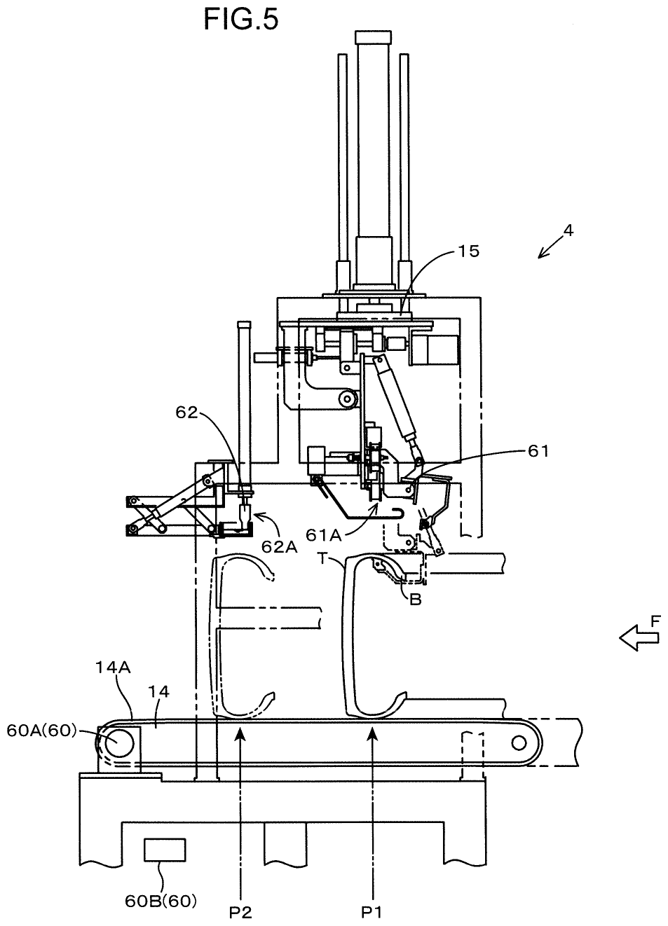

As depicted in FIG. 1, FIG. 4, and FIG. 5, the marking section 4 includes a pair of left and right third belt conveyors 14, a drive mechanism 60, and a marking device 15. The marking device 15 provides a plurality of marks indicating a result of the tire test at predetermined positions on the tire T (e.g. predetermined positions on the inner circumference of the tire T) positioned on the pair of third belt conveyors 14. The drive mechanism 60 drives the pair of third belt conveyors 14.

The paired third belt conveyors 14 each include a conveyance belt 14A provided thereon with the tire T having been subjected to the tire test and detached from the spindle unit 9 and configured to convey the tire T downstream in the conveyance direction. The pair of third belt conveyors 14 conveys, downstream in the conveyance direction, the tire T kept laid horizontally.

The conveyance belt 14A in each of the paired third belt conveyors 14 is constituted as a loop-shaped strip forming an endless track. The pair of third belt conveyors 14 adopts a belt conveyor system.

The drive mechanism 60 is configured to accurately control a conveyance position of the conveyance belt 14A in each of the paired third belt conveyors 14. As depicted in FIG. 5, the drive mechanism 60 according to the present embodiment includes a servomotor 60A (exemplifying a drive section) and a control section 60B. The servomotor 60A drives the conveyance belts 14A. The control section 60B operates the servomotor 60A to control the conveyance positions of the conveyance belts 14A. The control section 60B is constituted by a microcomputer or the like.

The marking device 15 includes a plurality of marking mechanisms having varied stamping systems. The plurality of marking mechanisms in the marking device 15 according to the present embodiment includes a first marking mechanism 61 and a second marking mechanism 62. The first marking mechanism 61 includes a first mark stamping device 61A configured to stamp a first mark indicating the result of the tire test in accordance with a first stamping system, on the tire T mounted on the conveyance belts 14A. The second marking mechanism 62 includes a second mark stamping device 62A configured to stamp a second mark indicating the result of the tire test in accordance with a second stamping system, on the tire T mounted on the conveyance belts 14A. The second stamping system is different from the first stamping system. Specifically, the first marking mechanism 61 is constituted as a high point marking mechanism configured to stamp a high point mark on a surface of the tire T in accordance with a thermal transfer system, whereas the second marking mechanism 62 is constituted as a grade marking mechanism configured to stamp a grade mark on the surface of the tire T in accordance with an ink stamp system.

The first mark stamping device 61A may include a marking head having a marking pin, and a thermal transfer tape to which the marking pin is pressed.

The second mark stamping device 62A may include a plurality of marking pins, and at least one ink pan containing ink. The plurality of marking pins is disposed such that tips of the marking pins are placed in the ink contained in the ink pan. When the second mark stamping device 62A marks the tire T, the ink pan departs from the tips of the plurality of marking pins and shifts to a position not disturbing shifting of the plurality of marking pins. Any one of the plurality of marking pins subsequently shifts toward the tire T to come into contact with the tire T and provide marking.

The marking section 4 executes the method of marking the tire T in the order of the following steps (a) to (d).

(a) The control section 60B in the drive mechanism 60 operates the servomotor 60A and controls the conveyance position of the conveyance belt 14A in each of the paired third belt conveyors 14 to shift the tire T mounted on the conveyance belts 14A to a predetermined position (a first tire position P1 indicated in FIG. 5) on the third belt conveyors 14. The first tire position P1 indicates a position of the tire mounted on the paired conveyance belts 14A. The first tire position P1 indicates a position of the tire T allowing the high point marking mechanism 61 to stamp the high point mark at a first marking position on the side wall surface of the tire T for stamping of the high point mark. As depicted in FIG. 5, the tire T disposed at the first tire position P1 according to the present embodiment has the side wall surface located right below the high point marking mechanism 61.

The tire testing section 3 detects the singular point as described earlier. In the tire testing section 3, the tire T held by the spindle unit 9 is preliminarily adjusted in terms of circumferential disposition of the tire T such that the singular point of the tire T has a phase (a circumferential position of the tire T) matching a phase of the pin (first mark stamping device) in the high point marking mechanism 61 stamping on the side wall surface of the tire T.

The tire testing machine 1 includes a storage constituted by a memory or the like and storing various types of information relevant to the tire test. The various types of information includes information on a diameter, rim size, or the like of the tire T to be tested, test conditions for the tire test, positional information relevant to a position of a mark indicating the result of the tire test provided on the tire T, and the like. The positional information includes information on a radial position on the side wall surface of the tire T to be provided with the mark. The radial position is preliminarily set for each type of the tire T, at a position less likely to have lack in the mark on the side wall surface. Specifically, the side wall surface of the tire T is provided with various designs and character strings, sizes and positions of which are different dependently on the type of the tire T. The mark provided on the side wall surface of the tire T by the marking device 15 has lack when overlapped with the designs and the character strings. The radial position is thus set at a position not provided with any of the designs or the character strings, in accordance with the type of the tire T.

The tire testing section 3 conducts the tire test to detect a high point (hardest site on the tire T) as the singular point. The tire testing section 3 rotates the tire T held by the spindle unit 9 such that the high point on the tire T has a phase matching the phase of the pin in the high point marking mechanism 61 stamping on the side wall surface of the tire T. The tire T is then transferred from the spindle unit 9 to the second conveyors 11, and is transferred from the second conveyors 11 to the third belt conveyors 14 (conveyors adjacent to the outlet). The radial position and a marking angle are preliminarily registered in the tire testing machine 1 for each type of the tire T to be tested. The marking angle indicates an angle described below. The tire to be marked has the side wall surface constituted by a complicated curved surface. In order to obtain a clean mark without lack, the marking pin is preferred to be pressed, as vertically as possible, against a site to be marked on the side wall surface. The tire testing machine 1 accordingly includes an angle adjustment mechanism configured to adjust the entire marking head including the marking pin at an appropriate angle in accordance with the type of the tire and the radial position. As described above, the marking angle indicates an angle of the marking head adjusted by the angle adjustment mechanism.

Grade marking provides a determination mark utilized for selection of the tire T or the like in a workplace and deleted before shipment of the tire T. The grade marking is thus not requested to achieve strict (precise) positioning. The grade marking is preliminarily set to a position having a phase difference of about 0 degrees or about 180 degrees from the position of the high point. When the grade marking is positioned to have the phase difference of about 0 degrees, the grade marking mechanism 62 has a fine adjustment function of preventing the grade mark provided by the grade marking mechanism 62 from overlapping the high point mark. The fine adjustment function enables the grade mark to be displaced from the high point mark. The grade marking according to the present embodiment is provided at a fixed position if the marking section 4 is determined in terms of its disposition during designing of the tire testing machine 1. The tire testing machine 1 may alternatively be configured to change the position of the grade mark in accordance with the type of the tire T or the like.

The tire T having been subjected to the tire test is conveyed to the marking section 4 by means of the pair of second belt conveyors 11 while keeping the phase (the phase for the high point mark to be initially stamped) adjusted by the tire testing section 3.

The pair of third belt conveyors 14 in the marking section 4 shifts the tire T having been subjected to the tire test to the first tire position P1 for high point marking. The first tire position P1 is located closer to an inlet of the marking section 4 than a second tire position P2.

The control section 60B in the drive mechanism 60 operates the servomotor 60A such that the first mark stamping device 61A in the high point marking mechanism 61 adopting the thermal transfer system matches a marking position (first marking position) for the high point determined on the tire T, to adjust the conveyance positions of the conveyance belts 14A in the pair of third belt conveyors 14.

(b) When the tire T shifts to the first tire position P1 on the paired third belt conveyors 14, the high point marking mechanism 61 adopting the thermal transfer system (exemplifying the first stamping system) provides first marking, or high point marking at the first marking position on the side wall surface of the tire T having been tested.

(c) The control section 60B in the drive mechanism 60 operates the servomotor 60A and controls the conveyance position of the conveyance belt 14A in each of the paired third belt conveyors 14 to shift the tire T to the second tire position P2 on the conveyance belts 14A in the third belt conveyors 14. The second tire position P2 is different from the first tire position P1. The second tire position P2 allows the grade mark (second mark) to be stamped by the grade marking mechanism 62 (second marking mechanism) at the second marking position on the side wall surface of the tire T for stamping of the grade mark. As depicted in FIG. 5, the second tire position P2 according to the present embodiment is separated downstream in the conveyance direction by a predetermined distance from the first tire position P1.

After the tire T is provided at the first tire position P1 with high point marking, the pair of third belt conveyors 14 shifts the tire T having been marked to the second tire position P2 for provision of grade marking, which is located downstream of the first tire position P1. The second tire position P2 is located closer to an outlet of the marking section 4 than the first tire position P1.

The control section 60B in the drive mechanism 60 operates the servomotor 60A such that the second mark stamping device 62A in the grade marking mechanism 62 adopting the ink stamp system matches a marking position (second marking position) for the grade determined on the tire T, to adjust the conveyance positions of the conveyance belts 14A in the pair of third belt conveyors 14.

(d) When the tire T shifts to the second tire position P2 on the paired third belt conveyors 14, the grade marking mechanism 62 adopting the ink stamp system (exemplifying the second stamping system) different from the thermal transfer system provides second marking, or grade marking at the second marking position on the side wall surface of the tire T having been tested.

The tire testing machine 1 and the method of marking the tire T with use of the tire testing machine according to the embodiment of the present invention provide control of the conveyance position of the conveyance belt 14A in each of the paired third conveyors 14 on the single conveyance route F and adopts at least two different stamping systems at a plurality of locations (e.g. two locations) separated from each other by the predetermined distance in the conveyance direction, to achieve stamping of a plurality of marks indicating the result of the tire test on the tire T.

The high point marking mechanism 61 adopting the thermal transfer system stamps the high point mark on the tire T at the first tire position P1 on the paired third belt conveyors 14, the third conveyors 14 then shift the tire T from the first tire position P1 to the second tire position P2, and the grade marking mechanism 62 adopting the ink stamp system stamps the grade mark on the tire T. The conveyance position on the conveyance belt 14A in each of the paired third belt conveyors 14 is controlled by the servomotor 60A and the control section 60B included in the drive mechanism 60.

The tire testing machine 1 according to the embodiment of the present invention includes the pair of third belt conveyors 15 each constituted by the belt conveyor. The tire T being conveyed is thus less likely to slide on the surfaces provided with the tire T, or the surfaces of the conveyance belts 14A, and the tire T is less likely to slide upon marking. A conveyor adopting the conventional roller conveyor system is likely to generate vibration of the tire being conveyed. The third belt conveyors 14 adopting the belt conveyor system in the tire testing machine 1 according to the embodiment are less likely to generate vibration of the tire T being conveyed and are less likely to cause displacement of the marking position.

The third belt conveyors 14 are constituted by the belt conveyors to inhibit rotation of the tire T mounted on the conveyance belts 14A and conveyed. Such a configuration will be described specifically.

The conventional roller conveyor includes a plurality of rollers that is rotatable about a horizontal axis perpendicular to the conveyance direction of the tire and is aligned in the conveyance direction to be spaced apart from each other in the conveyance direction. The plurality of rollers rotates to convey the tire mounted on the rollers. The roller conveyor includes the plurality of rollers disposed to be spaced apart in the conveyance direction and supporting the tire T. The tire T and the plurality of rollers are thus in contact with each other not continuously but intermittently. The present embodiment allows the tire T to be in continuous contact with each of the conveyance belts 14A having a belt shape extending in the conveyance direction. Even when each of the rollers in contact with the tire has a static friction coefficient not largely different from a static friction coefficient of each of the conveyance belts 14A in contact with the tire, the tire and the plurality of rollers have frictional force less than frictional force between the tire and the conveyance belt 14A in each of the third conveyors 14 due to intermittent contact mentioned above. The roller conveyor and the tire are thus likely to slide each other. Even when a motor configured to drive the roller conveyor has accurately controlled rotational speed, the roller conveyor fails to accurately control a conveyance amount of the tire. When the roller conveyor and the tire slide each other, the tire may rotate on the roller conveyor. In a case where the roller conveyor is adopted, there is needed an additional mechanism (position adjustment mechanism) configured to adjust the position of the tire in the conveyance direction in order to precisely adjust the radial position of the tire on the roller conveyor. In the case where the roller conveyor is adopted, the tire cannot be precisely adjusted in terms of circumferential disposition (a phase position), and the phase position thus has some variation. In the case where the roller conveyor is adopted, the tire is thus marked with variation of the phase position.

In contrast, the pair of third conveyors 14 adopting to the belt conveyor system as in the embodiment is less likely to cause slide of the tire T in comparison to the roller conveyor. The drive mechanism 60 accurately controls the conveyance position (conveyance amount) of the conveyance belt 14A in each of the third conveyors 14 to achieve accurate control of a relative position of the tire T to the marking device 15, specifically, accurate control of the radial position of the tire T as well as circumferential disposition (the phase position) of the tire T.

In the case where the roller conveyor is adopted, the position adjustment mechanism in the conveyance direction of the tire includes a positioning stopper or the like. The positioning stopper is configured to be shiftable between an inhibition position inhibiting a shift of the tire in the conveyance direction and an allowance position allowing the shift of the tire in the conveyance direction. Adoption of the roller conveyor needs the position adjustment mechanism described above. The position adjustment mechanism is needed because the slide is likely to occur and change in size of the tire leads to change in marking position on the side wall surface of the tire. The marking position is separated radially inward from an outer circumference position by a predetermined dimension on the side wall surface, and the predetermined dimension changes dependently on the tire size. Adoption of the roller conveyor needs precise positioning of the tire with use of the position adjustment mechanism described above.

In contrast, the tire testing machine 1 according to the embodiment includes the pair of third belt conveyors 14 adopting the belt conveyor system, and the tire thus has substantially no slide with respect to the conveyance belts 14A. The drive mechanism 60 accurately controls the conveyance position (conveyance amount) of the conveyance belt 14A in each of the third conveyors 14, and the tire T can thus be stopped such that the marking device 15 has a constant relative position to the position to be marked on the tire T. The marking mechanism 4 does not need the position adjustment mechanism described above.

According to the embodiment, the servomotor 60A and the control section 60B configured to control the servomotor can accurately adjust the conveyance position of the conveyance belt 14A in each of the third belt conveyors 14 adopting the belt conveyor system, to achieve precise and flexible control of a tire stopped position (positioning). This enables marking on the tire T at a precise position.

According to the embodiment, the grade marking position and the high point marking position may have identical phases, or may have the phase difference of 180 degrees.

The tire position can be accurately adjusted as described above in the embodiment. The high point marking mechanism 61 thus needs no radial positioning mechanism (centering mechanism) for the tire T. The grade marking mechanism 62 needs neither the tire positioning stopper (the position adjustment mechanism) nor the function of finely adjusting the tire position. This achieves simplification of the tire testing machine 1. The tire testing machine 1 accordingly has a largely reduced maintenance workload.

In the tire testing machine 1 according to the embodiment, high point marking is not provided to the tire T held by the spindle unit 9, but both high point marking and grade marking are provided to the tire T held on the conveyance belts 14A in the third belt conveyors 14. This achieves reduction in cycle time of the tire test. In other words, the device achieves improved performance in terms of reduction in cycle time.

The high point marking mechanism and the grade marking mechanism each have a certain size. In a case where the tire is provided with the high point mark and the grade mark at substantially same positions in the conveyance direction, the high point marking mechanism and the grade marking mechanism each need to include a withdrawal mechanism configured to prevent contact between the high point marking mechanism and the grade marking mechanism. This leads to complication in terms of the configuration of the tire testing machine.

According to the embodiment, the first marking mechanism 61 includes the first mark stamping device configured to stamp the first mark on the tire T, and the second marking mechanism 62 includes the second mark stamping device configured to stamp the second mark on the tire. The second mark stamping device upon stamping the second mark on the tire T is positioned to be separated by the predetermined distance in the conveyance direction from the position of the first mark stamping device upon stamping the first mark on the tire T. The predetermined distance is set to avoid contact between the first mark stamping device and the second mark stamping device. This aspect does not need the withdrawal mechanism and inhibits complication in terms of the configuration of the tire testing machine.

The embodiment disclosed herein should be regarded as being exemplary and nonlimitive at any point.

The embodiment exemplifies the thermal transfer system as the first stamping system and the ink stamp system as the second stamping system. The first stamping system and the second stamping system should not be limited to these systems according to the embodiment, but may adopt any other stamping systems as long as the systems are different from each other. Adoption of the stamping systems different from each other exerts the following advantage. For example, the mark stamped in accordance with the first stamping system and the mark stamped in accordance with the second stamping system can have erasing characteristics different from each other. Specifically, one of the stamping systems may adopt a system having difficulty in erasing the mark, and the other one of the stamping systems may adopt a system achieving easy erasing of the mark. Such adoption of the stamping systems different from each other facilitates proper use of the stamping systems according to marking purposes. Preferably, the first stamping system may adopt the thermal transfer system and the second stamping system may adopt any other stamping system such as the ink stamp system, which achieves the following additional advantage. The thermal transfer system achieves excellent quick drying. When the first stamping system adopts the thermal transfer system, the first mark stamped in accordance with the thermal transfer system is inhibited from being removed during marking according to the second stamping system even if the first mark receives external force caused by friction with part of the device.

The embodiment exemplifies the case where the first mark is the high point mark and the second mark is the grade mark. The first mark and the second mark should not be limited to those according to the embodiment but may have different marks. Preferably, the first mark may be the high point mark and the second mark may be a different mark such as the grade mark, which achieves the following additional advantage. The high point mark needs to have higher accuracy in marking position than another mark. When the tire is provided with the high point mark with use of the first marking mechanism before the second marking mechanism provides marking, the tire has conveyance distance and conveyance time until provision of the high point mark shortened as much as possible. This prevents as much as possible unexpected displacement of the marking position during tire conveyance to the first marking mechanism.

Particularly, the embodiment disclosed herein includes matters not disclosed explicitly, such as running conditions, operation conditions, various parameters, as well as dimensions, weight, volume, and the like of constituent elements. These matters have values set so as not to depart from an ordinarily implemented range by those skilled in the art and so as to be easily assumed by those skilled in the art.

As described above, the present invention provides a tire testing machine and a method of marking a tire with use of the tire testing machine, which enable provision of a mark indicating a result of a tire test at a precise position on the tire as well as shorten cycle time of the tire test.

Provided is a tire testing machine including: a belt conveyor including a conveyance belt configured to convey, downstream in a conveyance direction, a tire having been subjected to a tire test and detached from a spindle unit, the conveyance belt which is a loop-shaped strip forming an endless track; a drive mechanism including a drive section configured to drive the conveyance belt, and a control section configured to operate the drive section for control of a conveyance position of the conveyance belt; and a marking device including a first marking mechanism configured to stamp, in accordance with a first stamping system, a first mark indicating a result of the tire test on the tire mounted on the conveyance belt, and a second marking mechanism configured to stamp, in accordance with a second stamping system different from the first stamping system, a second mark indicating a result of the tire test on the tire mounted on the conveyance belt.

The marking device in the tire testing machine provides both the first mark and the second mark to the tire that has been subjected to the tire test, is removed from the spindle, and is mounted on the conveyance belts. This configuration achieves reduction in cycle time of the tire test in comparison to the case of providing a mark to the tire mounted to the spindle. The conveyor configured to convey the tire for provision of the first and second marks to the tire is not configured as the roller conveyor but is configured as the belt conveyor including the conveyance belt which is a loop-shaped strip forming an endless track, and the conveyance belt has the conveyance position controlled by the control section in the drive mechanism. The conveyance belt in the belt conveyor has the belt shape continuously extending from an upstream end to a downstream end in the conveyance direction. The conveyance belt can thus stably hold the tire T in comparison to the plurality of rollers included in the roller conveyor, as well as is less likely to cause slide with respect to the tire. The tire testing machine can thus provide the mark indicating the result of the tire test at the precise position on the tire.

Provided is a tire marking method of stamping the first mark and the second mark on the tire with use of the tire testing machine. The tire marking method is executed in the order of the following steps (a) to (d).

(a) Causing the control section in the drive mechanism to operate the drive section and control the conveyance position of the conveyance belt to shift the tire on the conveyance belt to a first tire position, to allow the first marking mechanism to stamp the first mark at a first marking position for stamping of the first mark on a surface of the tire.

(b) Inscribing, with use of the first marking mechanism, the first mark at the first marking position on the tire having shifted to the first tire position.

(c) Causing the control section in the drive mechanism to operate the drive section and control the conveyance position of the conveyance belt to shift the tire on the conveyance belt to a second tire position separated from the first tire position by a predetermined distance in the conveyance direction, to allow the second marking mechanism to stamp the second mark at a second marking position for stamping of the second mark on the surface of the tire.

(d) Inscribing, with use of the second marking mechanism, the second mark at the second marking position on the tire having shifted to the second tire position.

The tire marking method includes stamping the first and second marks on the tire with use of the tire testing machine, to achieve reduction in cycle time of the tire test as well as provision of the marks indicating the result of the tire test at precise positions on the tire. The marking method includes providing the first mark on the tire having shifted to the first tire position on the conveyance belt, and providing the second mark on the tire having shifted to the second tire position separated from the first tire position by the predetermined distance in the conveyance direction. This does not need provision of the withdrawal mechanism to each of the marking mechanisms, the withdrawal mechanism being for preventing contact between the first marking mechanism and the second marking mechanism. This inhibits complication in terms of the configuration of the tire testing machine.

1. A tire testing machine comprising:
a belt conveyor including a conveyance belt configured to convey, downstream in a conveyance direction, a tire having been subjected to a tire test and detached from a spindle unit, the conveyance belt which is a loop-shaped strip forming an endless track;
a drive mechanism including a drive section configured to drive the conveyance belt, and a control section configured to operate the drive section for control of a conveyance position of the conveyance belt; and
a marking device including a first marking mechanism configured to stamp, in accordance with a first stamping system, a first mark indicating a result of the tire test on the tire mounted on the conveyance belt, and a second marking mechanism configured to stamp, in accordance with a second stamping system different from the first stamping system, a second mark indicating a result of the tire test on the tire mounted on the conveyance belt.

2. A tire marking method of stamping the first mark and the second mark on the tire with use of the tire testing machine according to claim 1, the method comprising:
causing the control section in the drive mechanism to operate the drive section and control the conveyance position of the conveyance belt to shift the tire on the conveyance belt to a first tire position, to allow the first marking mechanism to stamp the first mark at a first marking position for stamping of the first mark on a surface of the tire;
stamping, with use of the first marking mechanism, the first mark at the first marking position on the tire having shifted to the first tire position;
causing the control section in the drive mechanism to operate the drive section and control the conveyance position of the conveyance belt to shift the tire on the conveyance belt to a second tire position separated from the first tire position by a predetermined distance in the conveyance direction, to allow the second marking mechanism to stamp the second mark at a second marking position for stamping of the second mark on the surface of the tire; and
stamping, with use of the second marking mechanism, the second mark at the second marking position on the tire having shifted to the second tire position.
